(19) United States
(12) Patent Application Publication
(10) Pub. No.: US 2002/0002619 A1
(43) Pub. Date: Jan. 3, 2002

(54) Computer system

(76) Inventor: Yuki Arai, Hachiouji (JP)

Correspondence Address: DICKSTEIN SHAPIRO MORIN & OSHINSKY LLP, Mark J. Thronson, 2101 L Street NW, Washington, DC, 20037-1526, US

(21) Appl. No.: 09/809,102

(22) Filed: Mar. 16, 2001

(30) Foreign Application Priority Data
Jun. 29, 2000 (JP) 2000-197085

(51) Int. Cl. G06F 15/16

(52) U.S. Cl. 709/229; 709/227

(57) ABSTRACT

In a computer system connected to a network, direct access from the computer network side to a computer is inhibited to prevent illegal data reading or rewriting, data destruction or the like. A first storage unit 106, a data recording unit 102 and a recording medium carrier 105 are connected to a first computer 101. A data reproducing unit 104 is connected to a second computer 103. The first computer 101 controls the data recording unit 102 to record data stored in the first storage unit 106 into a recording medium. Then, the first computer 101 controls the recording medium carrier 105 to carry the recording medium 110 from the data recording unit 102 to the data reproducing unit 104. The second computer 103 controls the data reproducing unit 104 to reproduce the data recorded in the recording medium 110, and then transmits the reproduced data through the Internet 109.

This application claims a priority based on Japanese Patent Application No. 2000-197085 filed on Jun. 29, 2000, the entire contents of which are incorporated herein by reference for all purposes.

### BACKGROUND OF THE INVENTION

The present invention relates to a computer system including a computer connected through a computer network such as the Internet or the like.

When computers are connected to a computer network [e.g., Local Area Network (LAN), Metropolitan Area Network (MAN), Wide Area Network (WAN), the Internet or the like], data transmission can be carried out among the plurality of computers through the computer network. For example, when there is a connection between a host computer and a terminal computer through the computer network, the terminal computer can access the host computer having a database, and read data stored in the database of the host computer.

### SUMMARY OF THE INVENTION

When the computer network to which the computers are connected is, for example, the Internet, a third party may access one of the computers (e.g., host computer) through the Internet, illegally read or rewrite data stored in the computer or a mass storage device (hard disk drive or the like) which is connected to the computer, or even destroy the data.

To prevent such illegal data reading or rewriting, or data destruction, generally, the security management of the computer has been carried out by use of a password or the like to put limitations on the access to the computer or by enciphering the data.

Even if such methods are used, however, because of the electrical connection of the computer to the computer network, there is still a possibility that the computer having the data is accessed through the computer network due to a password leakage or data deciphering, and illegal data reading or rewriting, or data destruction may be carried out.

Therefore, an object of the present invention is to provide a computer system configured to make it difficult to have a direct access to a computer having a storage unit, which stores data, through a computer network, whereby making it difficult to illegally read or rewrite the data and to destroy the data.

In a first aspect of the present invention, a computer system comprises a first computer, and a second computer which is connected to a computer network. A storage unit, a data recording unit, and a recording medium carrier are connected to the first computer. A data reproducing unit is connected to the second computer.

The first computer controls the data recording unit to record data stored in the storage unit into a recording medium. Then, the first computer controls the recording medium carrier to carry the recording medium from the data recording unit to the data reproducing unit.

On the other hand, the second computer controls the data reproducing unit to reproduce the data recorded in the recording medium. Then, the second computer transmits the reproduced data through the computer network.

In this case, the date recording unit may initialize the recording medium before recording the data thereinto.

In a second aspect of the present invention, a computer system comprises a first computer, and a second computer which is connected to a computer network. A storage unit, a first data recording and reproducing unit and a recording medium carrier are connected to the first computer. A second data recording and reproducing unit is connected to the second computer.

The first computer controls the first data recording and reproducing unit to record the data stored in the storage unit into a recording medium and also to reproduce the second computer information indicating a data reproducing state of the second computer recorded in the recording medium. Then, the first computer controls the recording medium carrier to carry the recording medium from the first data recording and reproducing unit to the second data recording and reproducing unit.

On the other hand, the second computer controls the second data recording and reproducing unit to reproduce the data recorded in the recording medium, and also record the second computer information into the recording medium. Then, the second computer transmits the reproduced data through the computer network.

In this case, the first data recording and reproducing unit may initialize the recording medium and record the data thereinto after the reproduction of the second computer information.

### BRIEF DESCRIPTION OF THE DRAWINGS

FIG. 1 is an exemplary view schematically showing a configuration of a computer system to which an embodiment of the present invention is applied.

FIG. 2 is a flowchart illustrating a data transmission operation in the computer system to which an embodiment of the present invention is applied.

FIG. 3 is an exemplary view schematically showing a configuration of a computer system to which another embodiment of the present invention is applied.

FIG. 4 is a flowchart illustrating a data transmission operation in the computer system to which another embodiment of the present invention is applied.

### DETAILED DESCRIPTION OF THE PREFERRED EMBODIMENTS

Next, the preferred embodiments of the present invention will be described.

According to the present invention, as a recording medium, various storage media can be used such as: an optical information recording medium such as an optical disk, a magneto-optical disk, or the like; a magnetic information recording medium such as a magnetic disk, a magnetic tape or the like; a semiconductor memory or the like. However, the embodiments will be described assuming that a recording medium is an optical disk.

In addition, at a data recording unit and first and second data recording and reproducing units described later, data recording includes the storing of data into a semiconductor memory, and data reproducing includes the reading of data from the semiconductor memory.

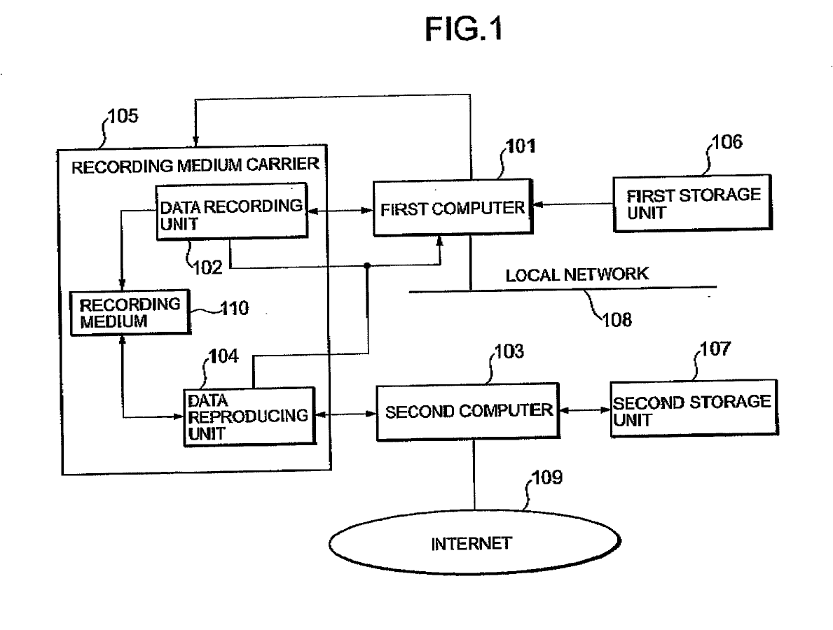

FIG. 1 is an exemplary view schematically illustrating the configuration of a computer system to which an embodiment of the invention is applied.

In FIG. 1, a data recording unit 102 is electrically connected to a first computer 101, and a data reproducing unit 104 is electrically connected to a second computer 103. The data recording unit 102 and the data reproducing unit 104 are physically connected to each other through a recording medium 110 by a recording medium carrier 105.

In the described embodiment, the first computer 101 is connected to a local network 108, which is not connected to the Internet 109.

The second computer 103 is not connected to the local network 108, but connected to the Internet 109. The second computer 103 may be connected to any other network, which is not connected to the local network 108.

A first storage unit 106 capable of storing mass data, such as a hard disk drive or the like, is connected to the first computer 101. The first computer 101 and the first storage unit 106 are, for example, host computers having databases.

The first computer 101 transmits data stored in the first storage unit 106 to the second computer 103 by controlling the data recording unit 102 and the recording medium carrier 105 described later. In this case, the first computer 101 controls the data recording unit 102 and the recording medium carrier 105 based on the later-described first status information and second status information.

Note that the first computer 101 can also transmit the data, which is stored in other devices connected to the local network 108 to the second computer 103.

At the data recording unit 102, based on the control of the first computer 101, data outputted from the first computer 101 is recorded into the recording medium 110 loaded by the later described recording medium carrier 105. Then, from the data recording unit 102, information indicating the loading/unloading of the recording medium 110 is outputted as first status information to the first computer 101.

A second storage unit 107 capable of storing mass data, such as a hard disk drive or the like, is connected to the second computer 103. The second storage unit 107 temporarily stores data obtained from the first computer 101.

In the described embodiment, the data obtained from the fist computer 101 is stored into the second storage unit 107. However, the second computer 103 may store such data into a built-in storage unit (not shown) and, as described later, read the data from the storage unit and transmit it to the Internet 109.

The second computer 103 temporarily stores the data reproduced from the recording medium 110 by the later described data reproducing unit 104 into the second storage unit 107, and then transmits the data to the Internet 109 therefrom.

The data reproducing unit 104 reproduces the data recorded in the recording medium 110 loaded by the later described recording medium carrier 105. The reproduced data is then transmitted to the second computer 103. Then, from the data reproducing unit 104, information indicating the loading/unloading of the recording medium 110 is outputted as second status information to the first computer 101.

Based on the control of the first computer 101, the recording medium carrier 105 carries the recording medium 110 between the data recording unit 102 and the data reproducing unit 104.

Connections are made respectively between the first computer 101 and the first storage unit 106, between the first computer 101 and the data recording unit 102, between the second computer 103 and the second storage unit 107, and between the second computer 103 and the data reproducing unit 104 through interfaces, for example, Small Computer System Interface (SCSI) or the like.

Connections are also made respectively between the first computer 101 and the data recording unit 102, and between the first computer 101 and the data reproducing unit 104 through interfaces for serial data transmission, for example, Recommended Standard 232C (RS232C) or the like.

The first computer 101 can accurately detect the operational states of the data recording unit 102 and the data reproducing unit 104 (whether or not the recording medium 110 is loaded, whether or not the recording medium 110 is being reproduced, and so on), based on the first status information sent from the data recording unit 102, and the second status information sent from the data reproducing unit 104.

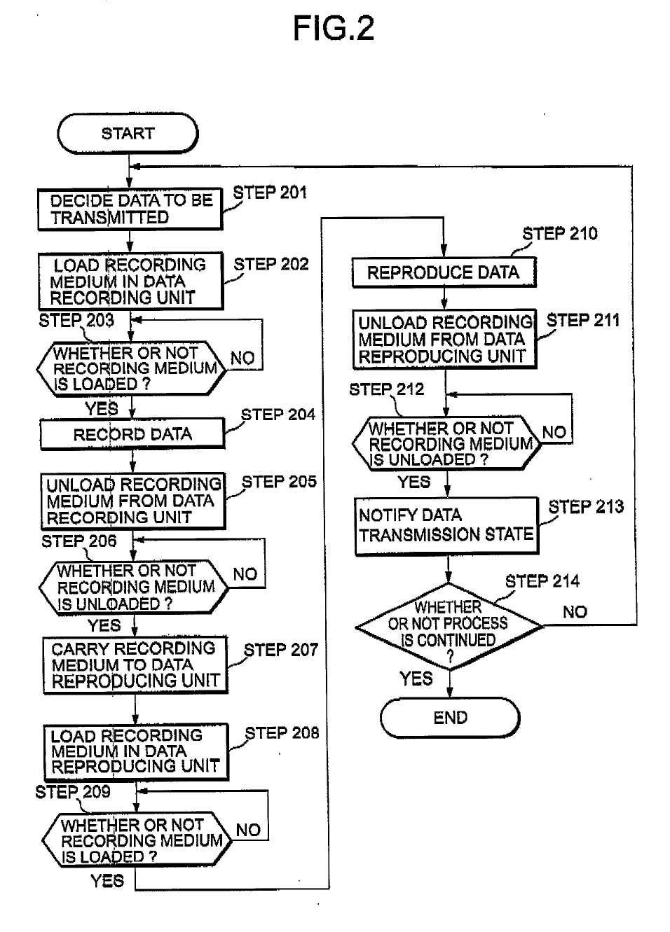

FIG. 2 is a flowchart illustrating a data transmission operation in the computer system to which an embodiment of the present invention is applied.

When the first computer 101 transmits data to the second computer 103, first, the first computer 101 decides the data to be transmitted among data stored in the first storage unit 106 (step 201). Then, the first computer 101 controls the recording medium carrier 105 to load the recording medium 110 in the data recording unit 102 (step 202).

Subsequently, the first computer 101 monitors the first status information of the data recording unit 102 at every constant interval of time, and is placed on standby until the recording medium 110 is loaded in the data recording unit 102 (step 203).

Upon detecting the completion of the loading of the recording medium 110 based on the first status information, the first computer 101 transmits the data to the data recording unit 102. Then, the data recording unit 102 is controlled to record the data into the recording medium 110 loaded in the data recording unit 102 based on a predetermined format (step 204).

After the end of the recording of the data into the recording medium 110, the first computer 101 controls the data recording unit 102 to unload the recording medium 110 from the data recording unit 102 (step 205).

Subsequently, the first computer 101 monitors the first status information of the data recording unit 102 at every constant interval of time, and is placed on standby until the recording medium 110 is unloaded from the data recording unit 102 (step 206).

Upon detecting the unloading of the recording medium 110 from the data recording unit 102 based on the first status information, the first computer 101 controls the recording medium carrier 105 to carry the recording medium 110 unloaded from the data recording unit 102 to the data reproducing unit 104 (step 207). Then, the recording medium 110 is loaded in the data reproducing unit 104 (step 208).

On the other hand, the second computer 103 accesses the data reproducing unit 104 at every constant interval of time to confirm whether the recording medium 110 is loaded in the data reproducing unit 104 or not. The first computer 101 detects the completion of the loading of the recording medium 110 in the data reproducing unit 104 based on the second status information of the data reproducing unit 104.

Upon confirming the loading of the recording medium 110 in the data reproducing unit 104, enabling the data to be reproduced (step 209), the second computer 103 controls the data reproducing unit 104 to reproduce the data from the recording medium 110, and stores the reproduced data into the second storage unit 107 (step 210).

After the completion of the data storing in the second storage unit 107, the second computer 103 transmits the data stored in the second storage unit 107 through the Internet 109. At the same time, the second computer 103 controls the data reproducing unit 104 to unload the recording medium 110 (step 211).

In this case, when the second computer 103 cannot control the unloading of the recording medium 110 from the data reproducing unit 104, the first computer 101 controls the recording medium carrier 105 after being placed on standby for a period of time necessary for data reproduction at the data reproducing unit 104, and unloads the medium from the data reproducing unit 104.

The first computer 101 monitors the second status information sent from the data reproducing unit 104. Then, upon confirming the completion of the unloading of the recording medium 110 from the data reproducing unit 104 based on the second status information (step 212), the first computer 101 notifies a data transmission state by use of a monitor or the like (step 213).

In the case of continuing the process, the first computer 101 executes the processes from step 201 to step 213 (step 214). In the case of finishing the process, the first computer 101 controls the recording medium carrier 105 to hold the recording medium 110, and places the carrier on standby. Thus, the process comes to an end.

As can be understood from the foregoing, according to the embodiment, the first and second computers 101 and 103 are not electrically connected to each other through a network or the like. Instead, these computers are connected to each other physically through the recording medium 110 carried by the recording medium carrier 105. Accordingly, it is impossible to make direct access to the first computer 101 from the Internet 109 through the second computer 103.

In addition, the data reproducing unit 104 connected to the second computer 103 is permitted only to reproduce the data recorded in the recording medium 110 and not to record the data. Thus, it is impossible to modify the data stored in the recording medium 110 from the Internet 109 through the second computer 103 and the data reproducing unit 104.

Therefore, since no direct access is possible from the Internet 109 to the first computer 101, the data stored in the first computer 101 itself or the data stored in the first storage unit 106 can be prevented from being illegally read, rewritten or destroyed.

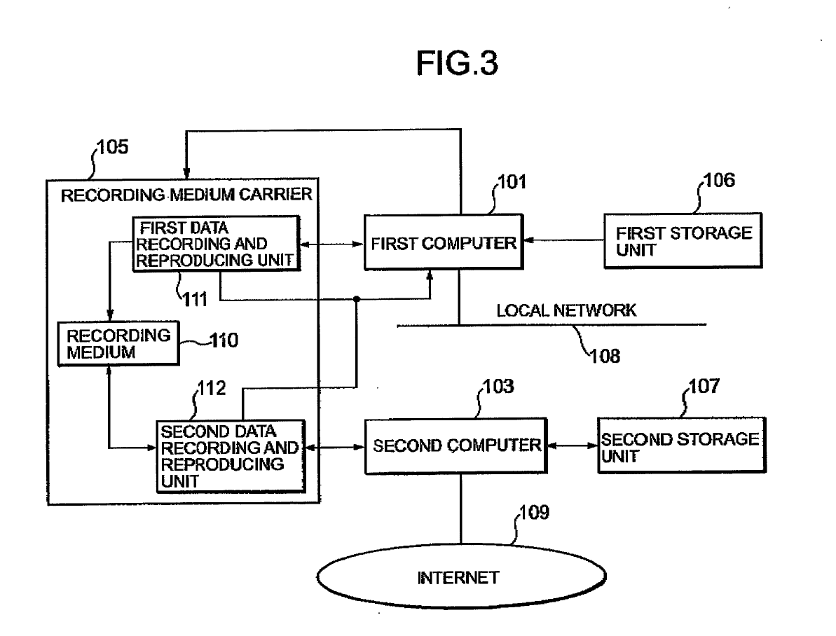

FIG. 3 is an exemplary view schematically illustrating the configuration of a computer system to which another embodiment of the present invention is applied.

The computer system shown in FIG. 3 is configured by making a few changes in the computer system shown in FIG. 1. Specifically, the data recording unit 102 is changed to a first data recording and reproducing unit 111; and the data reproducing unit 104 to a second data recording and reproducing unit 112. Other configurations are similar to those of the computer system shown in FIG. 1, and thus detailed description thereof will be omitted.

The first data recording and reproducing unit 111 records data into the recording medium 110, and reproduces second computer information recorded in the recording medium 110.

The second data recording and reproducing unit 112 reproduces the date recorded in the recording medium 110, and records the second computer information into the recording medium 110.

The first computer 101 determines whether the data has been normally transmitted or not based on the second computer information recorded in the recording medium 110. In addition, the first computer 101 controls the recording of the data into the recording medium 110 by the first data recording and reproducing unit 111, and the carriage of the recording medium 110 by the recording medium carrier 105.

The second computer 103 controls the second data recording and reproducing unit 112 to reproduce the data recorded in the recording medium 110. Then, when the second data recording and reproducing unit 112 reproduces the data normally, the second computer 103 controls the second data recording and reproducing unit 112 to record the second computer information into the recording medium 110.

In this case, the second computer information means the information indicating whether the reproduction of data from the recording medium 110 is accurately carried out or not. Such second computer information includes, for example, reproduction completion information indicating the completion of data reproduction, reproduction disability information indicating the disabled reproduction of data due to an error during data reproduction, writing incompletion information indicating the writing failure of data into the second storage unit 107 due to an error during data reproduction, and so on. Other than these, the second computer information also includes data transmission request information inputted to the second computer 103 through the Internet 109, and so on.

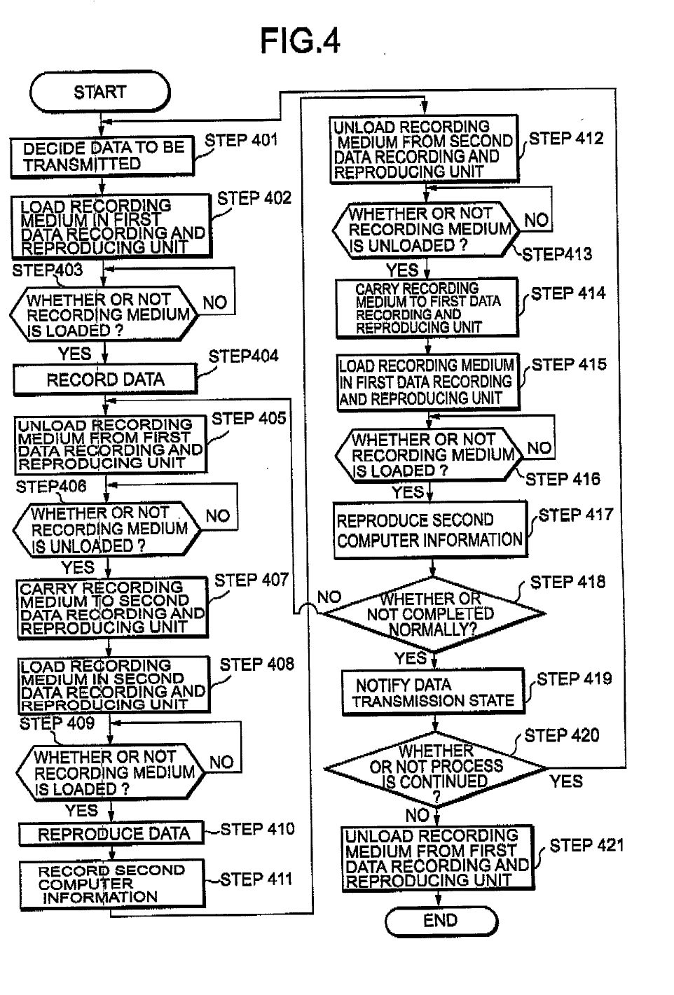

FIG. 4 is a flowchart illustrating a data transmission operation in the computer system according to another embodiment of the present invention.

When the first computer 101 transmits data to the second computer 103 first, the first computer 101 decides the data to be transmitted among data stored in the first storage unit 106 (step 401). Then, the first computer 101 controls the recording medium carrier 105 to load the recording medium 110 in the first data recording and reproducing unit 111 (step 402).

Subsequently, the first computer 101 monitors first status information sent from the first data recording and reproducing unit 111 at every constant interval of time, and is placed on standby until the recording medium 110 is loaded in the first data recording and reproducing unit 111 (step 403).

Upon detecting the completion of the loading of the recording medium based on the first status information, the first computer 101 transmits the data to the first data recording and reproducing unit 111. Then, by controlling the first data recording and reproducing unit 111, the first computer 101 records the data into the loaded recording medium 110 based on a predetermined format (step 404).

After the end of the data recording into the recording medium 110, the first computer 101 controls the first data recording and reproducing unit 111 to unload the recording medium 110 from the first data recording and reproducing unit 111 (step 405).

Subsequently, the first computer 101 monitors the first status information sent from the first data recording and reproducing unit 111 at every constant interval of time, and is placed on standby until the recording medium 110 is unloaded from the first data recording and reproducing unit 111 (step 406).

Upon detecting the completion of the unloading of the recording medium 110 from the first data recording and reproducing unit 111 based on the first status information, the first computer 101 controls the recording medium carrier 105 to carry the recording medium 110 unloaded from the first data recording and reproducing unit 111 to the second data recording and reproducing unit 112 (step 407). Then, the recording medium 110 is loaded in the second data recording and reproducing unit 112 (step 408).

On the other hand, the second computer 103 accesses the second data recording and reproducing unit 112 at every constant interval of time to verify whether the recording medium 110 is loaded in the second data recording and reproducing unit 112 or not. The first computer 101 detects the loading of the recording medium 110 in the second data recording and reproducing unit 112 based on second status information sent from the second data recording and reproducing unit 112.

Upon verifying the loading of the recording medium 110 in the second data recording and reproducing unit 112, enabling the data to be reproduced (step 409), the second computer 103 controls the second data recording and reproducing unit 112 to reproduce the data from the recording medium 110. Then, the reproduced data is stored into the second storage unit 107 (step 410).

Subsequently, when all the data reproduced from the recording medium 110 has been stored into the second storage unit 107, the second computer 103 controls the second data recording and reproducing unit 112 to record second computer information indicating the end of the data reproduction into the recording medium 110 (step 411).

After the completion of the recording of the second computer information, the second computer 103 transmits the data stored in the second storage unit 107 through the Internet 109. At the same time, the second computer 103 controls the second data recording and reproducing unit 112 to unload the recording medium 110 (step 412).

In this case, when the second computer 103 cannot control the unloading of the recording medium 110 loaded in the second data recording and reproducing unit 112, the first computer 101 controls the recording medium carrier 105 to unload the recording medium 110 from the second data recording and reproducing unit 112 after being placed on standbys for a period of time necessary for data reproduction in the second data recording and reproducing unit 112.

On the other hand, the first computer 101 monitors the second status information sent from the second data recording and reproducing unit 112. Upon confirming the unloading of the recording medium 110 from the second data recording and reproducing unit 112 (step 413), the first computer 101 controls the recording medium carrier 105 to carry the recording medium 110 from the second data recording and reproducing unit 112 to the first data recording and reproducing unit 111 (step 414). Then, the recording medium 110 is loaded in the first data recording and reproducing unit 111 (step 415).

Then, the first computer 101 monitors the first status information of the first data recording and reproducing unit 111. Upon confirming the loading of the recording medium 110 in the first data recording and reproducing unit 111 (step 416), the first computer 101 controls the first data recording and reproducing unit 111 to reproduce the second computer information from the recording medium 110 (step 417).

The first computer 101 then confirms whether the reproduction of the data in the second data recording and reproducing unit 112, the writing of the data into the second storage unit 107 or the like is completed normally or not based on the second computer information reproduced from the recording medium 110 (step 418).

In this case, when the first computer 101 verifies that the data reproduction by the second data recording and reproducing unit 112 and the data writing into the second storage unit 107 are not completed normally, the first computer 101 executes the processes from step 405 to step 418 again. On the other hand, when the first computer 101 verifies that the data reproduction by the second data recording and reproducing unit 112 and the data writing into the second storage unit 107 are completed normally, the first computer 101 notifies a data transmission state by use of a monitor or the like (step 419).

In the case of continuing the process, the first computer 101 executes the processes from step 401 to step 419 (step 420). In the case of finishing the process, the first computer 101 controls the recording medium carrier 105 to unload the recording medium 110 from the first data recording and reproducing unit 111 (step 421). Then, the first computer 101 also controls the recording medium carrier 105 to hold the recording medium 110, and places the carrier on standby. Thus, the process comes to an end.

As can be understood from the foregoing, according to the described embodiment, the first and second computers 101 and 103 are not electrically connected to each other through a network. Instead, these computers are physically connected to each other through the recording medium 110 carried by the recording medium carrier 105.

The second computer 103 can only reproduce the data recorded in the recording medium 110 and record the second computer information into the recording medium 110. The second computer 108 cannot have any direct access to the first computer 101.

Thus, it is possible to prevent the illegal reading, rewriting, destruction, or the like of the data stored in the first computer 101 itself or stored in the first storage unit 106 by accessing the first computer 101 through the Internet 109.

In addition, the first computer 101 can detect the failed reproduction of data in the second computer 103 or the failed writing of data into the second storage unit 107 based on the second computer information.

In the above case, the first computer 101 can control the recording medium 110 to stay loaded in the second data recording and reproducing unit 112 until the data reproduction in the second computer 103 and the data writing into the second storage unit 107 are completed normally. Accordingly, it is possible to accurately transmit the data from the first computer 101 side to the second computer 103 side.

Note that, in each of the foregoing embodiments, based on the first status information and the second status information, the first computer 101 controls the data recording unit 102 or the first data recording and reproducing unit 111, and the recording medium carrier 105. However, the present invention is not limited to this.

For example, the first computer 101 may output control signals to the data recording unit 102 or the first data recording and reproducing unit 111, and the recording medium carrier 105, the signals being used to control these. Then, after the passage of predetermined time, the first computer 101 may output a control signal for controlling a next operation.

In addition, the first computer 101 may control the data recording unit 102 or the first data recording and reproducing unit 111, and determine whether the recording medium 110 is loaded in the data recording unit 102 or the first data recording and reproducing unit 111 depending on the possibility of data recording into or data reproducing from the recording medium 110 by the data recording unit 102 or the first data recording and reproducing unit 111. Then, based on the result of the determination, the first computer 101 may output a control signal for controlling a next operation.

Moreover, in each of the foregoing embodiments, the data recording unit 102 may record the data in the recording medium 110 after the initialization of the recording medium 110. The first data recording and reproducing unit 111 may initialize the recording medium 110 and record the data thereinto after the reproduction of the second computer information. The second data recording and reproducing unit 112 may initialize the recording medium 110 and record the second computer information thereinto after the reproduction of the data.

Accordingly, it is possible to increase the quantity of data to be recorded into the recording medium 110. Also, it is possible to prevent a reproducing mistake, such as the reproduction of previously recorded data instead of reproducing the data to be reproduced among the data recorded in the recording medium 110.

As apparent from the foregoing, the present invention is advantageous in that it is difficult to illegally read, rewrite, or even destroy the data by direct access from the computer network side to the computer having the storage unit, which stores the data.

What is claimed is:

1. A computer system comprising:
a first computer; and
a second computer connected to a computer network,
wherein a storage unit, a data recording unit and a recording medium carrier are connected to said first computer, a data reproducing unit is connected to said second computer,
said first computer controls said data recording unit to record data stored in said storage unit into a recording medium, and then controls said recording medium carrier to carry said recording medium from said data recording unit to said data reproducing unit, and
said second computer controls said data reproducing unit to reproduce the data recorded in said recording medium, and then transmits the reproduced data through said computer network.

2. The computer system according to claim 1, wherein said data recording unit initializes said recording medium before said data is recorded into said recording medium.

3. A computer system comprising:
a first computer; and
a second computer connected to a computer network,
wherein a storage unit, a first data recording and reproducing unit, and a recording medium carrier are connected to said first computer, a second data recording and reproducing unit is connected to said second computer,
said first computer controls said first data recording and reproducing unit to record data stored in said storage unit into a recording medium, and reproduce second computer information indicating a data reproducing state of said second computer, recorded in said recording medium, and then controls said recording medium carrier to carry said recording medium from said first data recording and reproducing unit to said second data recording and reproducing unit, and
said second computer controls said second data recording and reproducing unit to reproduce the data recorded in said recording medium, and record said second computer information into said recording medium, and then transmits said reproduced data through said computer network.

4. The computer system according to claim 3, wherein said first data recording and reproducing unit initializes said recording medium and records said data into said recording medium after the reproduction of said second computer information.
